(19) United States
(12) Patent Application Publication
(10) Pub. No.: US 2019/0299331 A1
(43) Pub. Date: Oct. 3, 2019

(54) DEVICE FOR PROCESS MONITORING DURING LASER PROCESSING COMPRISING AN OPTICAL DISTANCE MEASURING DEVICE AND A PRISM DEFLECTION UNIT; LASER PROCESSING HEAD COMPRISING SUCH A DEVICE

(71) Applicant: PRECITEC GMBH & CO. KG, Gaggeenau (DE)

(72) Inventor: Rüdiger MOSER, Malsch (DE)

(73) Assignee: Precitec GmbH & Co. KG, Gaggeenau (DE)

(21) Appl. No.: 16/305,869

(22) PCT Filed: May 16, 2017
(86) PCT No.: PCT/EP2017/061673

§ 371 Date: Nov. 29, 2018

(30) Foreign Application Priority Data
May 30, 2016 (DE) 10 2016 109 909.0

(51) Int. Cl. B23K 26/21; G01B 11/02; G01B 11/22; B23K 26/03; B23K 26/06; B23K 26/064

(52) U.S. Cl. CPC B23K 26/21; G01B 11/026; B23K 26/064; B23K 26/032; B23K 26/0665; G01B 11/22

(57) ABSTRACT

The invention relates to a device for process monitoring during laser processing, in particular during laser welding and deep laser welding, comprising an optical distance measuring device having a measurement light source for generating a measurement light beam (14), which is focused onto a workpiece surface in order to form a measurement light spot, and comprising a prism deflection unit (24) having at least one prism (22) which is mounted rotatably about an axis (28) running transversely with respect to the measurement light beam (14) and which laterally deflects the measurement light beam (14) for positioning the measurement light spot on the workpiece surface.

The invention pertains to a device for process monitoring during the laser machining, particularly laser welding and laser deep welding, by means of an optical distance measurement. In this case, the distance measurement particularly may be carried out by means of optical coherence tomography.

In a distance measurement for process monitoring, a measurement beam usually is coaxially superimposed with a machining beam. In order to carry out various measuring tasks such as, for example, detecting the keyhole opening, measuring the welding penetration depth, i.e. the keyhole depth, reference measurements on the sheet surface, topography measurements in advance, e.g. for seam detecting and seam tracking, follow-up topography measurements, e.g. measuring the upper weld bead for fault detection and quality assurance, and the like, it must be possible to accurately position the point of impact of the optical measurement beam, i.e. the measurement spot, on the workpiece. For this purpose, the measurement beam, which is guided through a laser machining head, particularly through a laser welding head or laser welding scanner, has to be precisely deflected laterally.

The most challenging of the aforementioned measuring tasks is the measurement of the welding penetration depth, i.e. the measurement of the depth of the vapor capillary or the so-called keyhole being formed during welding in the interaction area between the working laser beam and the workpiece. Depending on process parameters such as the focal point diameter of the working laser beam, the laser power, the advance speed, the material, etc., the keyhole has a typical opening diameter of a few hundred micrometers and may in special instances also be considerably smaller. In order to receive an optimal depth signal from the keyhole bottom, the focal point of the measurement beam has to be aligned with the keyhole opening, which was previously determined experimentally, with the lateral accuracy of less than 25 μm. The optimal position is typically located behind the working laser beam and depends on the advance direction and the advance speed. A constant precise and fast adaptation of the measurement spot position relative to the working laser beam particularly is required in laser welding with scanners, i.e. with laser machining heads, in which the working focal point is periodically deflected transverse to the machining line, e.g. with a controlled oscillating mirror, but also in directionally independent welding with fixed optics.

In addition, the measurement spot has to be periodically deflected on the sheet surface in order to carry out distance measurements thereon. The actual keyhole depth and therefore the welding penetration depth can be determined from the difference between the distance to the sheet surface and the distance to the keyhole bottom. However, if the measurement spot is not exactly aligned with the keyhole opening and therefore the keyhole bottom, the measuring system acquires an incorrect distance value and the user receives incorrect information on the welding penetration depth such that the component in question typically is deemed to be defective and therefore rejected.

In order to carry out the aforementioned advance and follow-up topography measurements, the measurement beam has to be quickly and accurately deflected transverse to the machining line in order to scan the topography of the workpiece surface. Depending on the measuring task, the lateral deflection takes place over a range between a few millimeters and several tens of millimeters.

In order to accomplish the aforementioned measuring tasks, the deflection unit for the measurement beam therefore has to fulfill two complementary requirements. It has to ensure a fast and highly dynamic deflection of the measurement beam, as well as precisely reproducible positioning of the measurement spot in predefined positions. In this context, the precisely reproducible positioning should also be possible over prolonged periods of time, i.e. over several days to a few weeks.

Light beams are usually deflected by means of mirror optics. Galvo-motors, piezo-drives, MEMS (microelectromechanical systems) or other motor drives, which cause a defined rotational motion of the deflection mirror, may be considered as drives.

The law of reflection, i.e. angle of incidence=angle of reflection, applies to the reflection on a mirror. This means that a change of the mirror angle by the angle Φ leads to a deflection of the light beam by 2·Φ. Large deflection angles therefore can in fact be achieved, but the drift and inaccuracies of the drive are also amplified by a factor of two. Advantages and disadvantages of potential drives are briefly explained below:

The advantages of galvanometric drives (galvo-motors) are large deflection angles (≈0.35 rad), a very good reproducibility (≈2 μrad), high dynamics, i.e. fast pivoting and positioning, and large apertures when large mirrors are used. Analog position detectors particularly have the disadvantage of high long-term and temperature drift values. In the case of analog position detectors, typical galvo-scanners have a long-term drift in the range up to 600 μrad. This drift occurs in addition to a temperature-dependent drift, which typically lies around 15 μrad/K. Since the temperature normally cannot be maintained constant in production environments, the drift values quickly reach several hundreds of μrad, wherein the deflection of the optical light beam is due to the law of reflection subject to a drift that is twice as high. This drift already is excessive for carrying out the aforementioned measurement of the keyhole depth in a reliable and stable manner, particularly in combination with mirror optics.

In the meantime, various manufacturers also offer digital position detectors, the long-term drift values of which are lower by about one order of magnitude, but the costs for a corresponding system currently are still considerably higher. Even the enhanced long-term drift values cannot guarantee a reliable and stable operation because a temperature-defendant drift always occurs in addition to the long-term drift despite the digital position detector.

The rather compact piezo-scanners likewise have a very good angular resolution, but frequently only allow a small deflection angle of less than 10 mrad. Although models with larger deflection angles are also available on the market, the costs for such piezo-scanners are very high. Furthermore, the maximum mirror size and therefore the aperture of the measurement beam are limited due to the compact structural shape. Long-term and temperature drift values are rarely indicated.

Deflection units in the form of MEMS (microelectromechanical systems) have an extremely compact structural shape such that the maximum aperture is typically very limited to the range between 1 and 4 mm. Furthermore, these components are frequently operated in the resonant mode, i.e. the deflection mirror oscillates with its resonant frequency. So-called quasi-static MEMS, the manufacture of which is elaborate and therefore also expensive, are required for statically adjusting and maintaining an angle.

In order to realize the aforementioned welding penetration depth measurements and/or topography measurements, the measurement beam has to be guided through a laser machining head, particularly through a laser welding head or through a laser welding scanner, in order to coaxially superimpose the measurement beam with the machining beam. This means that the focusing element of the laser machining head is used for focusing the measurement beam. This focusing element typically has a focusing focal lengths in the range of 150 to 1000 mm. A small focal point size in the range of a few tens of μm is required for positioning the measurement light on the workpiece surface and, in particular, for focusing the measurement light in the keyhole opening, as well as for achieving a high lateral resolution during topography measurements. Due to the given large focusing focal length, a sufficiently large diameter of the collimated measurement beam is required for this purpose. Consequently, MEMS-based mirrors are unsuitable for this task. In contrast, piezo-scanners frequently have an excessively small deflection angle, which particularly is insufficient for the aforementioned topography measurements. Galvo-scanners are well suited with respect to their angular range, positioning accuracy and mirror size. However, they have the above-discussed problem of considerable drift values.

DE 40 26 130 C2 discloses a device for deflecting a light beam by means of two deflection mirrors that can be rotated about a rotational axis independently of one another. In this case, the law of reflection applies because the deflection of the laser beam is realized by means of mirrors. This means that a rotation of the mirror by the angle Φ leads to a deflection of the light beam by 2·Φ. Consequently, the drift and inaccuracies of the corresponding mirror drives are respectively amplified by a factor of two.

DE 44 41 341 C2 discloses a drum scanner, in which a tiltable prism is arranged in a collimated beam path in order to shift the focal point position transverse to the optical axis of the beam path for its precision adjustment or preadjustment. The actual dynamic beam deflection is realized with mirror optics on a rotation motor.

DE 10 2008 032 751 B3 discloses a laser machining device, in which two prisms are respectively arranged in a collimated laser beam in order to precisely adjust and align the two collimated laser beams in a point in space between two deflection mirrors of a galvo-scanner. The dynamic deflection required for this double-spot or multiple-spot laser machining process is realized by means of the mirror optics of the galvo-scanner.

DE 20 2008 017 745 U1 concerns a device for guiding a light beam and describes the utilization of a plane plate, which is rotatively driven and adjustable with respect to its tilting angle, in a convergent beam path, as well as the utilization of an optical group with complementary spherical surfaces that face one another. However, the utilization of a plane plate in the convergent beam path results in significant aberrations, which are disadvantageous for distance measurements.

DE 43 91 446 C2 concerns a laser beam scanner and describes the utilization of a rotatively driven prism for deflecting a collimated laser beam in order to achieve a circular path. The rotation of the prism takes place about the optical axis. The deflection angle of the laser beam remains constant in this case.

DE 198 17 851 C1 concerns a method for deflecting a laser beam and describes the utilization of two wedge plates with the same wedge angle, which are arranged so as to be rotatable about the optical axis independently of one another. In this way, the laser beam can be purposefully adjusted to any point on the circular area that is defined by the wedge angle. This method is also known as Risley-prism scanning. In order to achieve a linear scanning pattern, both wedge plates have to be rotated with predefined angular velocities.

DE 10 2016 005 021 A1 discloses a device for measuring the depth of the vapor capillary during a machining process with a high-energy beam, wherein a collimated measurement light beam is incident on a wedge plate that can be rotated about a rotational axis by means of a motor. In this case, the rotational axis extends perpendicular to a first plane face and transverse to the measurement light beam. The first plane face therefore acts as a deflection mirror and produces a first measurement light beam, the direction of which is likewise invariable. The second plane face includes an angle other than 90 degrees with the rotational axis. A second measurement light beam, which is inclined relative to the first measurement light beam in accordance with the wedge angle of the wedge plate, is thereby produced. In this case, the direction of propagation of the second measurement light beam depends on the orientation of the wedge plate. In this way, two measurement spots can be generated on the surface of the workpiece, wherein said measurement spots are always spaced apart from one another by the same distance regardless of the angle of rotation of the wedge plate. The angle of rotation of the wedge plate makes it possible to move the second measurement light spot around the first measurement light spot along a circular path.

JP 10-034366 A discloses a laser beam machining device, in which a working laser beam is focused in a focal point by means of a lens. A monitoring beam path is collimated by a collimator and incident on a wedge plate, the first face of which extends perpendicular to the incident measurement light beam. A plane-parallel plate is arranged behind the wedge plate referred to the beam direction and inclined relative to both faces of the wedge plate. When the wedge plate and the plane-parallel plate are jointly rotated about the optical axis, a measurement light spot moves around the optical axis along a corresponding circular path.

The invention is based on the objective of making available a device for process monitoring during laser machining, in which an optical measurement beam, which particularly is guided through a laser machining head, can be deflected quickly and in a precisely reproducible manner in order to position a measurement spot on a workpiece surface.

This objective is attained with the device according to claim 1. Advantageous embodiments and enhancements of the invention are described in the dependent claims.

According to the invention, a device for process monitoring during laser machining, particularly laser welding and laser deep welding, comprises an optical distance measuring device with a measurement light source for generating a measurement light beam, which is focused on a workpiece surface in order to form a measurement light spot, as well as a prism deflection unit with at least one prism, which is mounted so as to be rotatable about an axis extending transverse to the measurement light beam and laterally deflects the measurement light beam in order to position the measurement light spot on the workpiece surface. In this way, deviations from a desired position of the prism only have a minimized effect on the deflection accuracy of the measurement light beam because large rotational motions of the prism only result in relatively small deflections of the measurement light beam.

In order to guide the measurement light beam over a two-dimensional measurement or monitoring area, it is advantageous if the prism deflection unit comprises two prisms, which are arranged at an angle of 90° relative to one another and both mounted so as to be rotatable about an axis extending transverse to the measurement light beam, wherein the prism or prisms can be respectively rotated by actuating drives that can be activated independently of one another.

In order to ensure a fast and highly dynamic deflection of the measurement light beam for various measuring tasks, it is advantageous to provide a galvo-motor as actuating drive. Galvo-motors are reliable and easily controllable drives, the drift of which only has little effect on the positioning accuracy due to the optical reduction by the prism or prisms.

The prism deflection unit is advantageously arranged in a parallel section of the measurement light beam, particularly between collimator optics and focusing optics, wherein the collimator optics are inclined relative to the optical axis of the focusing optics. In this way, the measurement light beam extends essentially parallel to the optical axis of the focusing optics after the deflection by the prism or prisms.

In an advantageous embodiment of the invention, it is proposed that the prism or prisms of the prism deflection unit are provided with one or more antireflection layers, the transmission of which is configured for a broad angular range. Since a transmission of nearly 100% can thereby be achieved, the measurement light practically experiences no losses and it is possible to measure greater welding penetration depths. Interferences within the optics, which could lead to interfering signals in the measuring system, furthermore do not occur.

The inventive device for process monitoring during laser machining, particularly laser welding and laser deep welding, can be used in connection with a laser machining head, particularly a laser welding head or laser welding scanner, through which a machining laser beam is guided and in which focusing optics are arranged, wherein said focusing optics focus the machining laser beam in a working focal point on a workpiece. In this case, the measurement light beam is superimposed with the machining laser beam in that the measurement light beam is coupled into the machining laser beam by means of a beam splitter. In this case, the prism deflection unit is arranged between the collimator optics and the beam splitter.

Examples of the invention are described in greater detail below with reference to the drawings. In these drawings:

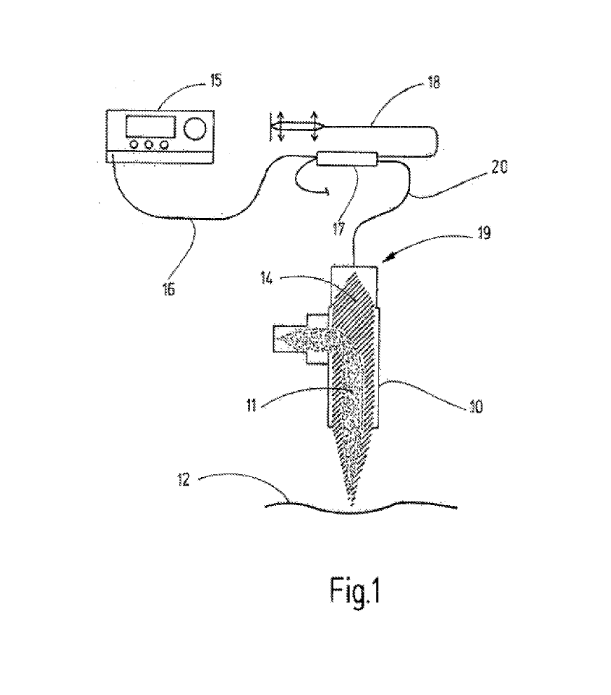

FIG. 1 shows a simplified schematic illustration of a laser machining head with an integrated device for process monitoring during laser machining according to the present invention,

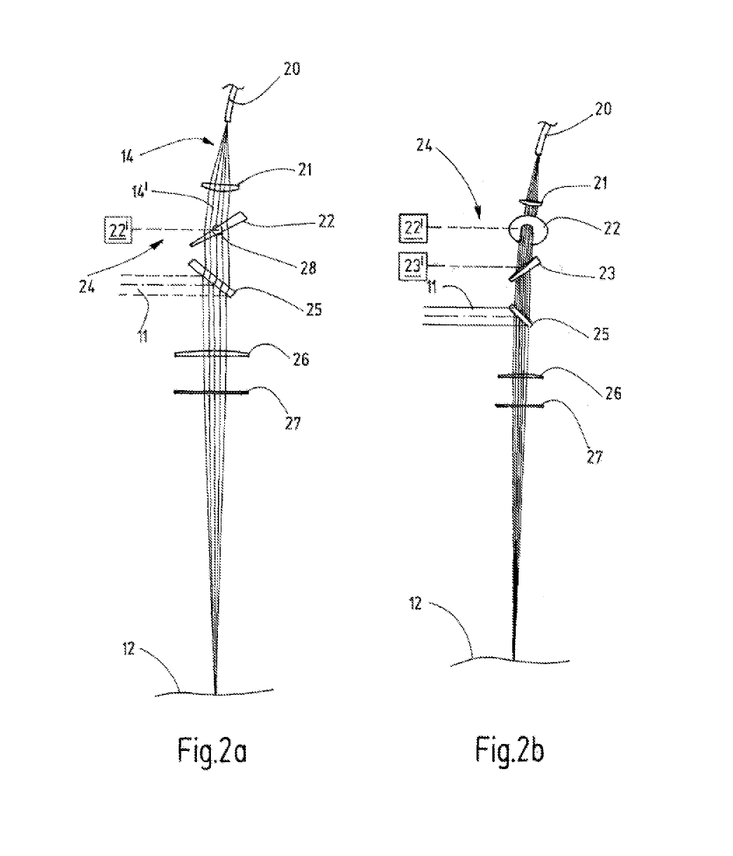

FIGS. 2a and 2b respectively show a simplified schematic illustration of a measurement beam path of a device for process monitoring during laser machining,

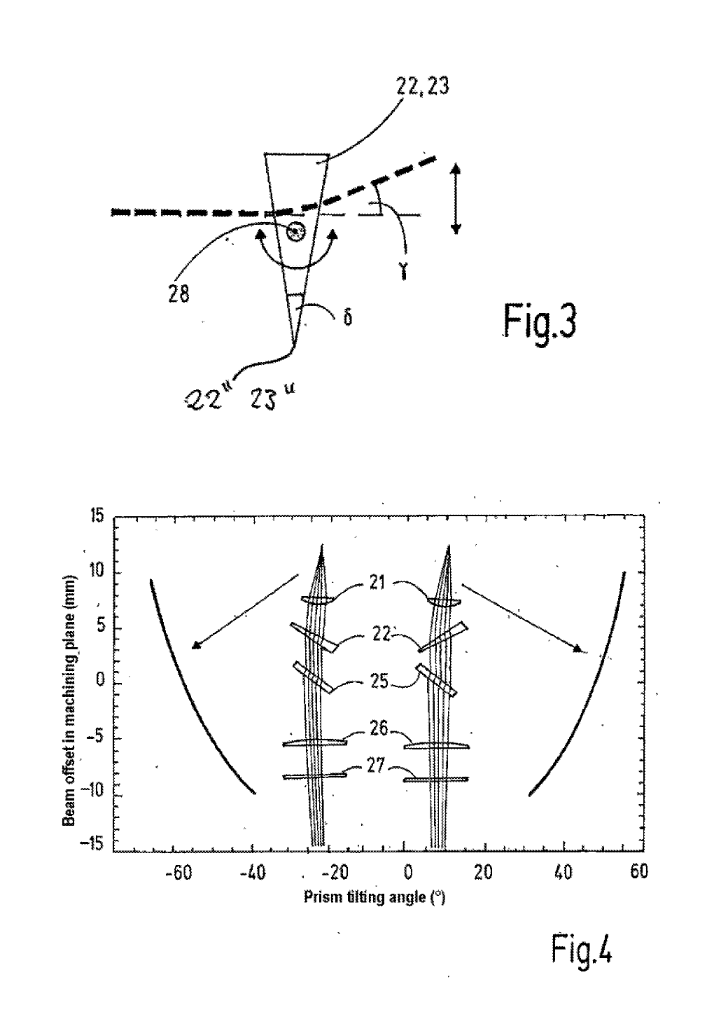

FIG. 3 shows an illustration of the deflection of a light beam by a prism in order to elucidate the functional principle of a prism deflection unit,

FIG. 4 shows an illustration of a beam offset in the machining plane in dependence on the tilting angle of the prism of the prism deflection unit,

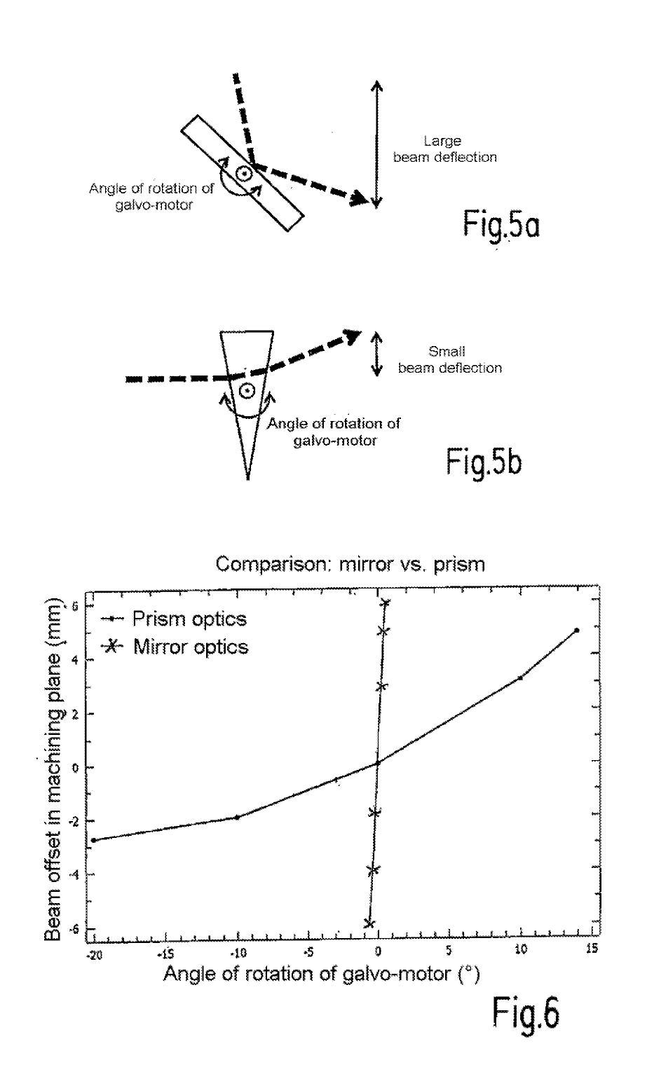

FIG. 5a shows a schematic illustration of a deflection unit with mirror optics,

FIG. 5b shows an illustration similar to FIG. 3 for comparing a prism deflection unit with a mirror deflection unit,

FIG. 6 shows an illustration of the beam offset in dependence on the angle of rotation of a mirror or prism drive,

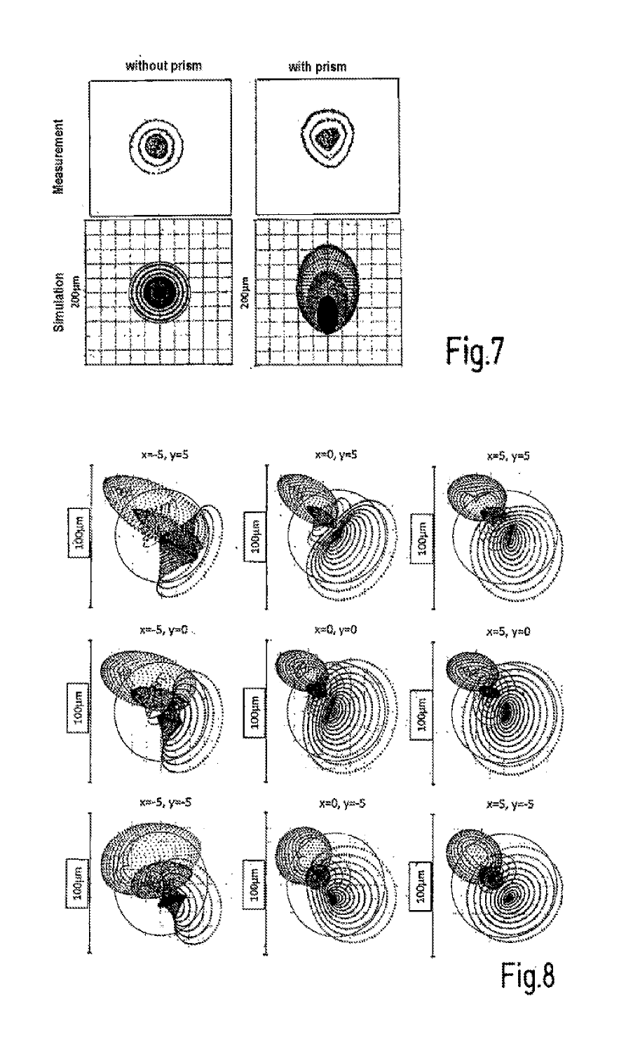

FIG. 7 shows measured and simulated beam profiles in the focal point of a measurement beam with and without prism, and

FIG. 8 shows simulated beam profiles in the focal point of a measurement beam that can be deflected by means of two successively arranged prisms.

In the different figures, corresponding elements are identified by the same reference symbols.

FIG. 1 schematically shows a laser machining head 10, through which a machining laser beam 11 is guided on the surface of a workpiece 12. The laser machining head 10 particularly may be a laser welding head or a laser welding scanner. A measurement light beam 14, which is described in greater detail below with reference to FIGS. 2a and 2b, is superimposed with the machining laser beam 11 in the laser machining head 10. The measurement light is guided from a not-shown light source, which is integrated into an evaluation unit 15 of a process monitoring device, to the laser machining head 10 via an optical waveguide 16, a beam splitter 17 and an additional optical waveguide 20. If the distance measurement is carried out in accordance with coherence tomography, the measurement light is split in the beam splitter 17, which preferably comprises a fiber coupler, and fed to a reference arm 18 and a measurement arm 19 that comprises the optical waveguide 20 and the beam path of the measurement light in the laser machining head 10.

According to FIG. 2a, the measurement light, which is emitted from the end face of the optical waveguide 20 in a divergent manner, is collimated by collimator optics 21 in order to form a parallel measurement light beam 14′. The parallel measurement light beam 14′ is deflected by a prism 22 of a prism deflection unit 24 and incident on a beam splitter 25, by means of which the measurement light beam 14 is superimposed with the machining laser beam 11 as indicated with broken lines in FIG. 2a. The machining laser beam 11 and the parallel measurement light beam 14′ are then respectively focused in a machining focal point and a measurement spot by means of common focusing optics 26, in front of which a protective glass 27 is arranged on the beam emission side. In this case, the refracting edge 22″ of the prism 22, i.e. the intersecting line of its two refracting faces that include the wedge angle or vertically opposed angle δ of the prism (see FIG. 3), extends parallel to the rotational axis 28 such that the tilting angle of the prism 22, i.e. the angle of its two refracting faces relative to the incident light beam (optical axis of the collimator optics 21), can be purposefully varied by rotating the prism. The position of the measurement spot can be purposefully shifted relative to the machining focal point by means of the tilting angle of the prism 22 relative to the optical axis of the machining beam path, which can be adjusted by means of an actuating drive 22′.

In order to realize the positioning of the measurement spot relative to the machining focal point in the advance direction, as well as perpendicular thereto, the beam control optics for the measurement light beam 14 comprise a second prism 23 in addition to the prism 22, wherein this second prism is arranged in such a way that its wedge angle, i.e. its refracting edge 23″, extends perpendicular to the wedge angle, i.e. the refracting edge 22″, of the first prism 22. The rotational axes 28 of the two prisms 22, 23, which are arranged parallel to their refracting edges 22″, 23″, therefore also extend perpendicular to one another. Both prisms 22, 23 can be rotated or tilted and thereby adjusted as desired by means of associated actuating drives 22′, 23′, which can be activated independently of one another.

According to the invention, the beam deflecting element used is not realized in the form of mirror optics, but rather one or two prisms 22, 23, i.e. transmissive prism optics. In contrast to mirror optics that are subject to the law of reflection, no mechanical rotational motion of a mirror is therefore converted into an optical beam deflection that is twice as large, which would correspond to an optical transmission ratio. In fact, the mechanical rotational motion is reduced and results in a small optical deflection.

The following advantages with respect to the aforementioned measuring tasks are achieved in combination with a rotary drive that can be quickly positioned, e.g. a galvo-motor:

The occurring drift motions of the (not-shown) galvo-motor, which serves as actuating element for the prism 22, are optically reduced such that the measurement spot position can be prevented from drifting away from the vapor capillary. The scanning field required for advance and follow-up topography measurements can be completely scanned despite the reduction. Due to the optical reduction, the galvo-motor operates in its full angular range and can be optimally utilized. The prism or prisms 22, 23 of the prism optics can also be combined with other drive concepts such as piezo-drives, belt drives, etc.

FIG. 3 shows the prism 22, 23, which is mounted so as to be rotatable or tiltable about a rotational axis 28 (perpendicular to the plane of projection) that extends perpendicular to the not-shown optical axis of the measurement light beam path, in order to elucidate the function of a one-dimensional prism deflection unit. The prism 22, 23 can be rotated by means of a likewise not-shown rotary drive.

Based on the law of refraction and geometric relations, the equation for the overall deflection angle of a prism, which is known from the relevant literature, reads as follows:

$$γ = {α}_{1} - δ + arcsin ( sin δ \sqrt{{( \frac{{n}_{1}}{{n}_{2}} )}^{2} - {sin}^{2} {α}_{1}} - cos δ sin {α}_{1} ) .$$

In this case, α1 denotes the angle of incidence relative to the surface normal, n1 and n2 respectively denote the indices of refraction of the ambient medium and the prism material and δ denotes the vertically opposed angle of the prism.

The minimal deflection angle occurs at symmetric light transmission. The applicable equation reads as follows:

$${γ}_{m i n} = 2 arcsin ( \frac{{n}_{1}}{{n}_{2}} sin \frac{δ}{2} ) - δ .$$

If the light transmission deviates, the deflection angle increases during a positive rotation, as well as a negative rotation, of the prism 22, 23. This behavior is illustrated in FIG. 4 based on a 1D (one-dimensional) prism deflection unit, which is arranged between the collimator 21 and the 45° beam splitter 24. Since a prism always deflects the beam in the same direction regardless of the prism angle, the optical axis of the collimator 21 is inclined relative to the optical axis of the focusing optics 25 such that the beam can be deflected in the positive direction, as well as in the negative direction, from a chosen zero position in the reference system of the machining plane, i.e. the workpiece surface. According to FIG. 4 and the above equation, no linear correlation between tilting angle and beam offset results in the machining plane. However, this behavior can be corrected by means of a correction function in the activation of the drive.

FIG. 4 shows the result of a simulation of the beam offset in the machining plane as a function of the angle of rotation or tilting angle of the prism optics of the beam deflection unit for a laser machining head with a focusing focal length of f=300 mm. The collimation unit, i.e. the collimator 21, was inclined by 5° in order to allow a perpendicular transmission through the focusing optics 25. The vertically opposed angle of the prism amounted to 7.68°. Due to the refractive property, the prism 22 can be used in two angular ranges in order to realize a beam offset in the positive and in the negative direction.

The left half of FIG. 4 shows the beam offset in the machining plane when the prism 22 is rotated from the position for symmetric light transmission in the clockwise direction whereas the right half of FIG. 4 shows the beam offset in the machining plane when the prism 22 is rotated in the counterclockwise direction. An angular position, which represents a zero position with respect to the position of the measurement spot in the machining plane, can be found for both situations. This angular position lies at about −58° referred to the position for symmetric light transmission when the prism 22 is rotated in the clockwise direction and at about 48° when the prism 22 is rotated in the counterclockwise direction.

In a mirror deflection unit of the type illustrated in FIG. 5a, small angles of rotation of the drive (galvo-motor) already lead to a large beam deflection whereas even relatively large angles of rotation of the drive and therefore the prism only lead to a relatively small beam deflection in a prism deflection unit of the type illustrated in FIG. 5b. FIG. 6 shows a comparison between a prism scanner and a conventional mirror scanner. Due to the optical reduction in the prism optics, the angle of rotation of a typical galvo-motor is almost completely utilized. In mirror optics, the drive only operates in a very limited angular range such that inaccuracies and drift motions do not allow stable positioning on the opening of a keyhole in typical production environments.

FIG. 6 particularly shows the lateral beam offset in the machining plane of a laser machining head with a focusing focal length of f=300 mm as a function of the angle of rotation or tilting angle of prism optics (line with dots) and mirror optics (line with the crosses). The vertically opposed angle of the prism amounts to 7.68°. The prism and the mirror are arranged in the collimated beam.

Due to the wavelength-dependent index of refraction, chromatic splitting occurs during the transmission of spectrally broadband measurement light. FIG. 7 shows the measured and the simulated intensity distribution in the focal point of a measurement beam, i.e. the measurement spot, which was focused by means of the machining optics, i.e. the focusing optics of a laser machining head with a focusing focal length of f=300 mm. The light source used had a spectral width of 40 nm. During the measurement without prism deflection unit or scanner, a round, Gaussian and diffraction-limited intensity profile is formed in the focal point in the measurement, as well as in the simulation. Reduced chromatic splitting is achieved by using a prism in the collimated beam path, i.e. an arrangement of the type illustrated in FIG. 2a. The beam profile still approximates the diffraction-limited intensity distribution such that the measurement spot is suitable for measuring the depth of the vapor capillary.

FIG. 8 shows simulated intensity distributions when two prisms 22, 23, which are arranged at an angle of 90° relative to one another (2D (two-dimensional) prism scanner or deflection unit), are used at different positions in a scanning field in a machining plane with a size of about 10 mm×10 mm, which is typical for the aforementioned measuring task. Regardless of the scanning field position, the beam profile has a size that approximates the diffraction limit such that the measurement beam can be completely focused in a keyhole opening even if it passes through two successively arranged prisms. A high lateral resolution can also be achieved in topography measurements because the measurement spot diameter has a small size of less than 100 μm. Due to the utilization of two prisms 22, 23, which are arranged at an angle of 90° relative to one another as illustrated in FIG. 2b, the measurement light beam 14 can be positioned in any position within the scanning field. Each prism only deflects the measurement beam in one direction.

In order to carry out the distance measurement for determining the keyhole depth, the measurement spot is alternately focused on the keyhole and on the workpiece 12 adjacent to the weld seam in a reproducible manner with the two prisms 22, 23 of the prism deflection unit. The prisms 22, 23 are statically held in their respective positions during the respective measurements.

In advance and follow-up topography measurements, one prism 22 (or 23) serves for positioning the measurement spot in the desired scanning area whereas the other prism 23 (or 22) guides the measurement light spot over the scanning area during its rotation.

The inventive utilization of a prism in combination with a fast and highly dynamic drive, e.g. a galvo-motor, makes it possible to achieve a beam deflection that is adapted to the respective process monitoring requirements during laser welding. In order to realize a two-dimensional deflection unit, two prisms are arranged at an angle of 90° relative to one another. This deflection unit in combination with an optical distance measuring system, e.g. an optical coherence tomography system, makes it possible to reliably carry out the initially cited measuring tasks. Significant advantages of the invention can be seen in that drift motions of the measurement beam in the machining plane can be significantly reduced and that the entire angle of rotation of the drive can be used due to the optical reduction by the prism optics.

1. A device for process monitoring during laser machining,
particularly laser welding and laser deep welding, comprising
an optical distance measuring device with a spectrally broadband measurement light source for generating a measurement light beam, which is focused on a workpiece surface in order to form a measurement light spot, and
with an evaluation unit, which is adapted for carrying out the distance measurement in accordance with coherence tomography, as well as
a prism deflection unit with at least one prism, which is mounted so as to be rotatable about an axis extending transverse to the measurement light beam in such a way that the measurement light beam can be purposefully shifted laterally relative to the optical axis by means of the tilting angle of the prism in order to position the measurement light spot on the workpiece surface,
wherein the measurement light beam is guided through the at least one prism in such a way that the measurement light beam is only deflected on the refracting faces of the least one prism.

2. The device according to claim 1, characterized in that the prism deflection unit comprises two prisms, which are arranged at an angle of 90° relative to one another and both mounted so as to be rotatable about an axis extending transverse to the measurement light beam.

3. The device according to claim 1, characterized in that the prism or prisms can be respectively rotated by means of an actuating drive, wherein the actuating drives can be activated independently of one another.

4. The device according to claim 3, characterized in that a galvo-motor is provided as actuating drive.

5. The device according to claim 1, characterized in that the prism deflection unit is arranged in a parallel section of the measurement light beam, particularly between collimator optics and focusing optics.

6. The device according to claim 5, characterized in that the collimator optics are inclined relative to the optical axis of the focusing optics.

7. The device according to claim 1, characterized in that the prism or prisms of the prism deflection unit are provided with one or more antireflection layers, wherein the transmission of the antireflection layers is configured for a broad angular range.

8. A laser machining head, through which a machining laser beam is guided and in which focusing optics are arranged that focus the machining laser beam in a working focal point on a workpiece, comprising a device for process monitoring during laser machining, particularly laser welding and laser deep welding, according to one of the preceding claims, wherein the measurement light beam is superimposed with the machining laser beam.

9. The laser machining head according to claim 8, characterized in that the measurement light beam is coupled into the machining laser beam by means of a beam splitter, and in that the prism deflection unit is arranged between collimator optics and the beam splitter.
